(19) United States
(12) Patent Application Publication
(10) Pub. No.: US 2005/0048995 A1
(43) Pub. Date: Mar. 3, 2005

(54) System and method for controlling the operating characteristics of a buffer

(75) Inventors: John McFarland Harris, Chicago, IL (US); Ronald T. Crocker, St. Charles, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/647,424

(22) Filed: Aug. 25, 2003

(51) Int. Cl. H04M 1/00

(52) U.S. Cl. 455/550.1; 455/73

(57) ABSTRACT

A system and method for controlling the operating characteristics of a buffer in a mobile unit. At least one communication from a source mobile unit may be received in a play-out buffer at a destination mobile unit. The play-out buffer may have an associated play-out depth. The communications received at the play-out buffer may be played to a recipient at the destination mobile unit. The remaining play-out depth of the play-out buffer in the destination mobile unit may be determined. An indication may be formed and sent to the source mobile unit when the remaining play-out depth of the play-out buffer in the destination mobile unit reaches a predetermined threshold.

### FIELD OF THE INVENTION

The invention relates generally to two-way communication systems and more particularly to call management procedures within these systems.

### BACKGROUND OF THE INVENTION

Systems and methods for transmitting voice communications in a wireless manner are well known. In a wireless system, a sender at a source mobile unit may send a communication to a recipient at a destination mobile unit. The communication will usually be transmitted from the source mobile unit to the destination mobile unit across a wireless infrastructure.

Typically, a voice coder (vocoder) at the source mobile unit is used to encode the communication to be transmitted, for example, into a sequence of frames. Before transmission to the destination mobile unit, the communication is often stored in a buffer or buffers within the infrastructure. Then, after the infrastructure locates the destination mobile unit, the infrastructure transmits the communication to the destination mobile unit. At the destination mobile unit, the communication can be stored in a “play-out” buffer. After a sufficient amount of voice data has been stored (or “queued”) in the play-out buffer, the communication may then be sent to a vocoder at the destination mobile unit, where the message is decoded and converted into a format that enables the communication to be presented to the intended recipient, for example, as an audible signal at a speaker.

One problem that arises in many of the above-mentioned systems is maintaining the audio quality and minimizing the delay of the voice messages played to the recipient. To achieve optimum audio quality and minimize delay, it is preferred that a continuous (or substantially continuous) stream of data flow from the play-out buffer to the vocoder at the destination mobile unit. However, if transmission errors, for example, frame erasures (FERs), occur between the source mobile unit and the infrastructure or from the infrastructure to the destination mobile unit, it is known that the play-out buffer will become empty (or nearly empty) while buffers in the infrastructure remain full (or nearly full). In other words, a large amount of information stored in the buffer in the infrastructure will only slowly drain to the play-out buffer. As the destination mobile unit waits for a sufficient amount of data to become available in the play-out buffer, a significant delay in the presentation of the voice message to the recipient and a possible degradation of signal quality may occur.

Changing the vocoder rate may affect play-out buffer usage and previous systems have allowed for the alteration of vocoder rate based upon general measures of network congestion. This capability has not particularly improved the situation noted above. In fact, significant audio delays may still occur within these systems.

### BRIEF DESCRIPTION OF THE DRAWINGS

FIG. 1 is a block diagram of one example of a system in accordance with one embodiment of the invention;

FIG. 2 is a call-flow diagram showing the controlling of the operating characteristics of a buffer in accordance with one embodiment of the invention;

FIG. 3 is a block diagram of one example of a mobile unit in accordance with one embodiment of the invention;

FIG. 4 is a block diagram of another example of a mobile unit in accordance with one embodiment of the invention; and

FIG. 5 is a block diagram of one example of a communication infrastructure in accordance with one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENTS

Pursuant to many of these embodiments, a system and method for controlling the operating characteristics of a buffer in a mobile unit is provided. At least one communication from a source mobile unit may be received in a play-out buffer at a destination mobile unit. The play-out buffer may have an associated play-out depth, which relates to the amount of data present in the play-out buffer or the amount of time that the target could continue to play audio before running out of audio, if the target were to stop receiving audio. The communications received at the play-out buffer may be played to a recipient at the destination mobile unit. The remaining play-out depth of the play-out buffer in the destination mobile unit may be determined. An indication may be formed and sent to the source mobile unit when the remaining play-out depth of the play-out buffer in the destination mobile unit reaches a predetermined threshold.

Pursuant to a preferred embodiment, the communications from the source mobile unit to the destination mobile unit are encoded at a coding rate and transmitted to the destination mobile unit. The source mobile unit receives the indication transmitted from the destination mobile unit and then adjusts the coding rate of the communications sent from the source mobile unit to the destination mobile unit as a function, at least in part, of the indication received from the destination mobile unit or send the actual size of the play-out buffer.

Pursuant to another preferred approach, the source mobile unit includes a vocoder and the coding rate of the source mobile unit is altered by adjusting the coding rate of this vocoder. In one embodiment, the indication is in the form of a real-time transport protocol (RTP) header. In another embodiment, the indication is in the form of a negative acknowledgment message (NAK). Conveniently, the NAK may be generated at either the destination mobile unit or within the infrastructure.

Thus, the operating characteristics of the play-out buffer in the destination mobile unit are controlled by adjusting the coding rate of a vocoder in the source mobile unit. Advantageously, the information is communicated from the destination mobile unit to the source mobile unit quickly and in real-time so that effective adjustments can be made to the coding rate at the source mobile unit. These real-time adjustments minimize or eliminate audio-delay or audio-quality problems at the destination mobile unit created when the play-out buffer at the destination mobile unit is emptied (or nearly emptied) of data.

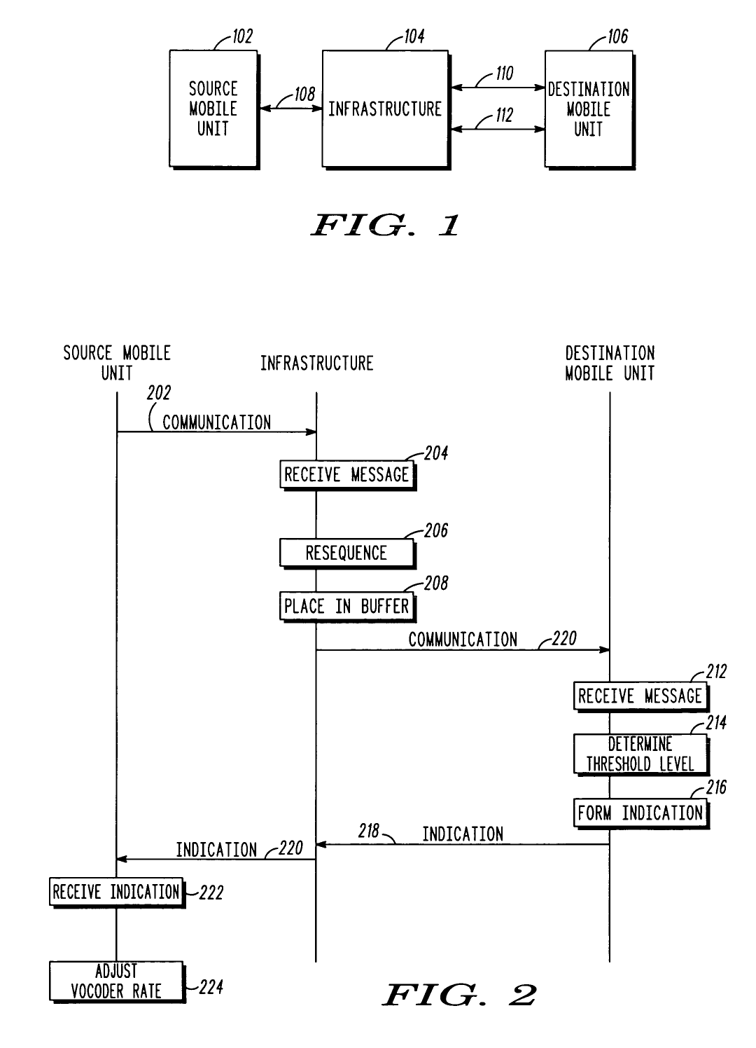

Referring initially to FIG. 1, a system for controlling the operating characteristics of a buffer at a destination mobile unit preferably includes a source mobile unit 102, a wireless infrastructure 104, and a destination mobile unit 106. The source mobile unit 102 is communicatively coupled to the wireless infrastructure 104 via a communication channel 108. The wireless infrastructure 104 is communicatively coupled to the destination mobile unit 106 via a communication channel 110 and optionally by a supplemental communication channel 112. The system of FIG. 1 may provide any type of telecommunication services. In one example, the system may provide Dispatch (DC) over Service Option (SO) 33 packet data services as is known in the art.

The source and destination mobile units 102 and 106 may be any type of wireless communication device. For example, they may be any cellular phone, pager, personal digital assistant or any combination of these devices that is capable of transmitting and receiving information in a wireless manner. In addition, the mobile units 102 and 106 may conform to any standard or group of standards. In one example, the mobile units 102 and 106 may conform to the CDMA-2000 group of standards.

The wireless infrastructure 104 may be any type of telecommunication infrastructure that is used to establish wireless communication sessions between different mobile units. For example, the wireless infrastructure 104 may include switches, routers, base stations, buffers, servers, and control units that transmit and route any type of communication between mobile units. The wireless infrastructure 104 may conform to any standard or group of standard. In one example, the wireless infrastructure 104 may conform to the CDMA-2000 group of standards.

The communication channels 108, 110, and 112 may be any communication mechanism used to communicate any type of information between two points. In one example, they may include multiple channels, for example, traffic and control channels, as specified by the Radio Link Protocol (RLP) and the CDMA 2000 group standards or by the Radio Link Control (RLC) and the 3GPP group of standards. Preferably, the communication channels 108, 110, and 112 support two-way communication.

In one example of the operation of the system of FIG. 1, at least one communication is received at the destination mobile unit 106 from the source mobile unit 102. For example, the communication may be a voice communication, which has been encoded into a series of frames at a coding rate by a vocoder at the source mobile unit 102. The communication can be transmitted from the source mobile unit 102 to the infrastructure 104 via the communication channel 108 and from the infrastructure 104 to the destination mobile unit 106 via the communication channel 110.

The destination mobile unit 106 may include a play-out buffer, which has an associated play-out depth. The play-out depth may be a measure of the amount of remaining space left in the play-out buffer or the amount of time that the target could continue to play audio before running out of audio, if the target were to stop receiving audio. The communication may be received at the play-out buffer and played to a recipient at the destination mobile unit 106.

In a preferred approach, the destination mobile unit 106 determines the remaining play-out depth of the play-out buffer. An indication may be formed at the destination mobile unit 106 and sent to the source mobile unit 102 when the remaining play-out depth of the play-out buffer in the destination mobile unit 106 reaches a predetermined threshold. The indication may use an existing construct, for example, an RTP header or NAK, to indicate that the rate of the vocoder should be adjusted by a predetermined amount. In another example, the construct may itself carry information containing the remaining play-out depth of the play-out buffer and the vocoder rate may be adjusted accordingly. Other examples of indications are possible.

In one example, the indication is sent from the destination mobile unit 106 to the infrastructure 104 via the communication channel 110 and from the infrastructure 104 to the source mobile unit 102 via the communication channel 108. In another example, the indication is sent from the destination mobile unit 106 to the infrastructure 104 via the supplemental communication channel 112 and from the infrastructure 104 to the source mobile unit 102 via the communication channel 108. In another example, a NAK may be generated by the infrastructure 104 upon determining that an expected frame has not been received. In this case, it is assumed that a transmission error has occurred and the vocoding rate should be adjusted. Thus, in this example, an indication need not be formed in the destination mobile unit 106, but may be generated (in the form of the NAK) in the infrastructure 104 and sent to the source mobile unit 102.

The source mobile unit 102 may receive the indication. After analyzing the indication, the source mobile unit 102 may adjust the coding rate of the vocoder. For example, if the indication received is a NAK, then this NAK is analyzed to determine if the NAK originated because of a request for retransmission for a frame that was originally sent more than a threshold number of seconds in the past. A NAK received for a frame that was originally sent a longer time than the threshold can imply that the play-out buffer is low.

The rate may be adjusted by a predetermined amount, for instance, decreased by more than 50 percent, or, if the indication includes the remaining play-out depth, by an appropriate amount based upon this depth. The change in coding rate causes information to drain from buffers in the infrastructure to the play-out buffer.

Thus, the operating characteristics of the play-out buffer in the destination mobile unit 106 are controlled by adjusting the coding rate of a vocoder in the source mobile unit 102. Adjustments can be made to the coding rate of the vocoder at the source mobile unit quickly and in real-time. By doing so, audio-delay and audio-quality problems at the destination mobile unit 106 may be reduced, avoided, or eliminated altogether.

Referring now to FIG. 2, one example of a corresponding method is described. In this example, a source mobile unit transmits communications to a destination mobile unit via a wireless infrastructure. At step 202, the source mobile unit transmits a voice message to the infrastructure. For example, the source mobile unit may send a voice message including a plurality of frames of information over a traffic channel (TCH) that has been set up between the source mobile unit and the destination mobile unit.

At step 204, the infrastructure receives the voice message. For example, the infrastructure may place the message in a re-sequencing queue. At step 206, the frames may be re-sequenced. Re-sequencing the frames may be needed because the frames arrived out-of-order, as is the case when a frame is erased and needs to be retransmitted.

At step 208, the frames may be placed in a transmission buffer in the infrastructure for transmission to the destination mobile unit. At step 210, the infrastructure sends the voice message to the destination mobile unit. For example, this may be accomplished over a standard wireless traffic channel.

At step 212, the frames are received at the destination mobile unit and placed in a play-out buffer. At step 214, it may be determined whether the play-out depth of the play-out buffer has reached a predetermined threshold. At step 216, assuming the predetermined threshold has been reached, an indication is formed at the destination mobile unit and, at step 218, is sent from the destination mobile unit to the infrastructure. The indication may be sent via a standard communication channel or a supplemental communication channel.

At step 220, the indication may be sent from the infrastructure to the source mobile unit. In one example, the information may be communicated from the destination mobile unit to the infrastructure via an RTP header or NAK. If the indication received is a NAK, then this NAK is analyzed to determine if the NAK originated because of a request for retransmission for a frame that was originally sent more than a threshold number of seconds in the past.

Alternatively, a NAK may be generated by the infrastructure upon determining that an expected frame has not been received. In this case, it is assumed that a transmission error has occurred and the vocoding rate should be adjusted. Thus, in this example, an indication need not be formed in the destination mobile unit as described above, but may be generated (in the form of the NAK) in the infrastructure and sent to the source mobile unit.

At step 222, the source mobile unit may receive the indication, analyze the indication, and determine an adjustment for the vocoder within the source mobile unit. At step 224, the vocoder rate of the source mobile unit may be adjusted based upon the indication.

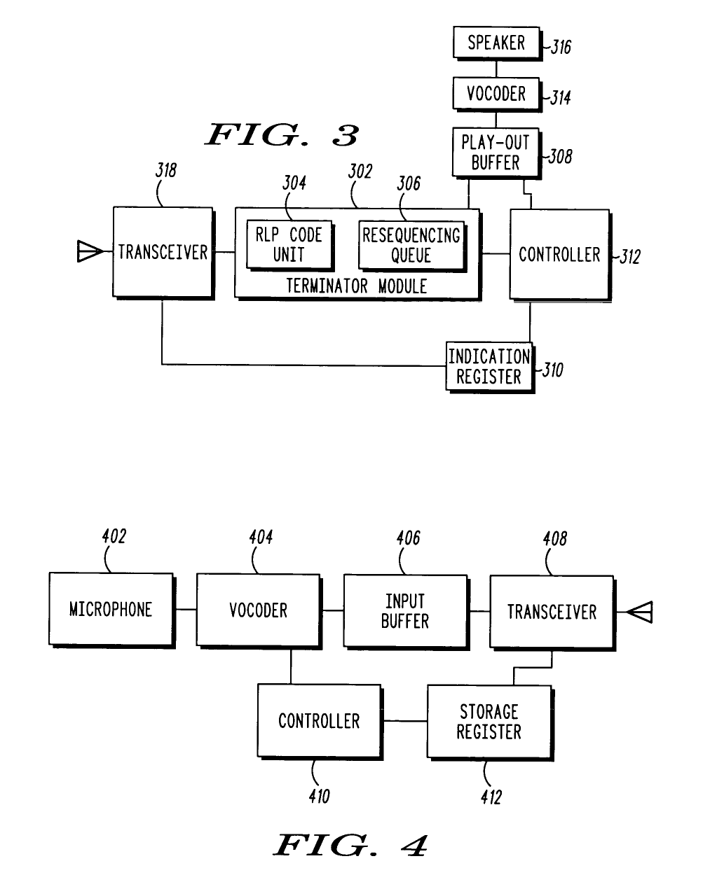

Referring now to FIG. 3, one example of a destination mobile unit suitable to support such actions is described. The mobile unit includes a terminator module 302 (including a RLP code unit 304 and re-sequencing queue 306), a play-out buffer 308, an indication register 310, a controller 312, a vocoder 314, a speaker 316, and a transceiver 318. The terminator module 302 is coupled to the transceiver 318 and the controller 312. The controller 312 is coupled to the play-out buffer 308 and the indication register 310. The indication register 310 is coupled to the transceiver 318. The play-out buffer 308 is coupled to the vocoder 314. The vocoder 314 is coupled to the speaker 316.

The terminator module 302 includes the RLP code unit 304 and the re-sequencing queue 306. As is known in the art, the RLP code unit 304 controls the types of messages entering the re-sequencing queue 306. The re-sequencing queue 306 assembles the frames received in the proper sequence. For example, the frames may be received out-of-order and the re-sequencing queue can assemble the frames in the proper order.

The play-out buffer 308 may be any type of storage device that can store any type of data. For example, the play-out buffer 308 can be a standard buffer that holds voice frames. The play-out buffer 308 may have an associated play-out depth. The play-out depth may be a measure of how much data is in the play-out buffer 308 at the specified time or the amount of time that the destination mobile unit must wait to queue a voice message to the recipient or the amount of time that the target could continue to play audio before running out of audio, if the target were to stop receiving audio.

A predetermined threshold may be determined for the play-out depth of the play-out buffer 308. If this threshold is reached, the play-out buffer has reached the play-out depth indicating that the amount of data in the play-out buffer 308 has reached a lower threshold or the amount of time that the target could continue to play audio before running out of audio, if the target were to stop receiving audio, has reached a threshold.

The indication register 310 can be used by the controller 312 to form an indication. The indication may take any number of forms. For example, it may be in the form of an RTP header. The indication can be used to indicate that the play-out buffer has reached the predetermined depth and that the coding rate of the vocoder should be adjusted. Alternatively, the indication may be generated as a NAK. Other forms of indications are possible. In addition, the indication may include the remaining play-out depth of the play-out buffer.

The controller 312 may be any type of processor that is capable of executing computer instructions stored in a memory. The controller 312 may form the indication in the indication register 310, monitor the play-out-buffer 308 for the situation where the predetermined threshold is reached, and send the indication to the infrastructure (via the transceiver 318) when required.

The vocoder 314 may be any type of audio processor that is capable of transforming analog speech signals into digital signals and converting digital signals into speech. For example, the vocoder 314 may receive data in a digital format and transform this data into electrical signals representing speech so that the speaker 316 can play the voice message (represented by the message) in an audible format to a recipient.

The speaker 316 can be any type of electrical or electronic device that can play electrical signals representing speech to the recipient. In one example, the speaker 316 is of the type commonly used in cellular phones.

The transceiver 318 may be any type of device that is capable of receiving data transmitted in a wireless manner or transmitting data over a wireless communication channel. For example, the transceiver 318 may include an antenna, which may both receive data over a wireless channel and transmit data over a wireless channel.

In one example of the operation of the mobile unit of FIG. 3, voice messages are received at the transceiver 318. The voice messages may be sent through the RLP code unit 304, which regulates which messages are allowed to enter the system. Next, the re-sequencing queue 306 may place the frames of the messages in the proper sequence. For example, if frames were numbered 1-6, but received in the order 1, 3, 4, 5, 6, and 2, then the re-sequencing queue places the frames in the correct order (i.e., 1,2,3,4,5,6).

The play-out buffer 308 may then receive the voice message. The play-out buffer 308 then may transmit the messages to the vocoder 314. The vocoder 314 transforms the frames into an electrical signal. The electrical signal is preferably sent to the speaker 316, such that the recipient at the destination mobile unit can hear the voice message.

The controller 312 may monitor the play-out depth of the play-out buffer 308. If the play-out depth reaches a predetermined value, then the controller 312 may form an indication in the indication register. In one example, the indication can be in the form of an RTP header. Other examples and forms of indications are possible. The indication may then be sent to the transceiver 318 where the indication is transmitted to the infrastructure. After receipt, the infrastructure can transmit the indication to the source mobile unit.

The transmission from the transceiver 318 can be accomplished over traffic channels as is known in the art. Alternatively, the transmission from the transceiver 318 may occur via a supplemental channel between the destination mobile unit and the infrastructure.

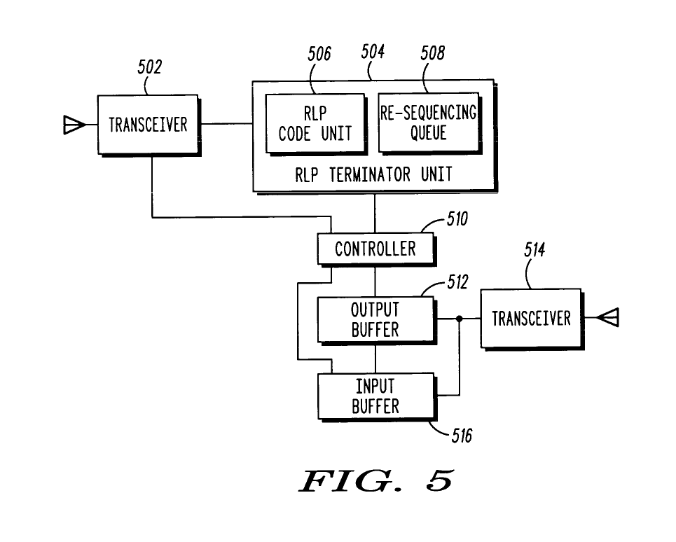

Referring now to FIG. 4, one example of a source mobile unit suitable to support the above-mentioned actions is described. The mobile unit includes a microphone 402, a vocoder 404, an input buffer 406, a transceiver 408, a controller 410, and a storage register 412. The microphone 402 is coupled to the vocoder 404. The vocoder 404 is coupled to the input buffer 406. The input buffer 406 is coupled to the transceiver 408. The transceiver 408 is coupled to the storage register 412. The storage register 412 is coupled to the controller 410. The controller 410 is coupled to the vocoder 404.

The microphone 402 may be any device that receives human audio input and converts this into an electrical signal. In one example, the microphone may be any standard microphone used with a cellular phone.

The vocoder 404 may be any type of audio processor that is capable of transforming analog speech signals into digital signals and converting digital signals into speech. For example, the vocoder 404 may receive data in an analog electrical signal and transform the signal into a digital, encoded format for transmission across a wireless network.

The input buffer 406 may be any type of data storage device that stores information in any form. For example, the input buffer 406 may receive and store encoded voice frames from the vocoder 404.

The transceiver 408 may be any type of device that is capable of receiving data transmitted in a wireless manner or transmitting data over a wireless communication channel. For example, the transceiver 408 may include an antenna, which may both receive data over a wireless channel and transmit data over a wireless channel.

The controller 410 may be any type of device that executes computer instructions stored in a memory. For example, the controller 410 may analyze the contents of the storage register 412 to see if an indication exists in the storage register 412. The controller 410 may then determine whether to decrease or increase the coding rate of the vocoder 404 based upon the received indication in the storage register 412. If the indication includes the remaining play-out depth of the buffer, the controller 410 can determine the amount of adjustment to the vocoding rate. Other functions may be performed by the controller 410, as well.

The storage register 412 may be any type of storage device that is used to hold any type of information. For example, the storage register 412 may hold the indication after the indication is received at the transceiver 408.

In one example of the operation of the mobile unit of FIG. 4, a sender at the source mobile unit speaks a voice message into the microphone 402. The message may be received and encoded via the vocoder 404 at a coding rate. The message can be placed in the input buffer 406 in preparation for transmission. When ready, the controller 410 may transmit the message via the transceiver 408.

In addition, the transceiver 408 may receive an indication. The storage register 412 may receive and store the indication received from the transceiver 408. For example, the indication may be in the form of a NAK or an RTP header. When an indication is received, the controller 410 may extract the indication from the storage register 412 and analyze the indication. The controller 410 may then adjust the coding rate of the vocoder 404 as required by or derived from the indication (or information included in the indication). For example, the coding rate may be reduced by one-half upon receipt of any RTP header or NAK. In another example, the RTP header may include information relating to the size of the play-out buffer. The controller 412 may extract this information and adjust the coding rate as required.

Referring now to FIG. 5, one example of a wireless infrastructure suitable to support such actions is described. The wireless infrastructure includes a transceiver 502, an RLP terminator unit 504 (including and RLP code unit 506 and an RLP re-sequencing queue 508), controller 510, output buffer 512, transceiver 514, and an input buffer 516. The transceiver 502 is coupled to the RLP terminator unit 504. The RLP terminator unit 504 is coupled to the controller 510. The controller 510 is coupled to the output buffer 512, input buffer 516, and transceiver 502. The input buffer 516 is coupled to the transceiver 514.

The transceiver 502 may be any type of device that is capable of receiving data transmitted in a wireless manner or transmitting data over a wireless communication channel. For example, the transceiver 502 may include an antenna, which may both receive data over a wireless channel and transmit data over a wireless channel.

The RLP terminator unit 504 includes the RLP code unit 506 and the RLP re-sequencing queue 508. The RLP code unit 506 may regulate the flow of information into the re-sequencing queue 508. The RLP re-sequencing queue 508 may place the frames of the messages in the proper sequence. For example, if frames were numbered 1-6, but received in the order 5,4,6,3,2,1, then the re-sequencing queue 508 may place the frames in the correct order (i.e., 1,2,3,4,5,6).

The controller 510 may be any type of processor that routes information within the infrastructure. The controller 510 may perform other functions as well. In one example, the controller is a chat server as is known in the art.

The input buffer 512 and output buffer 516 may be any type of data storage devices that store information in any form. For example, the output buffer 512 may store frames of the voice message before the frames are transmitted from the infrastructure to the destination mobile unit. In another example, the input buffer 516 may store an indication as received from the destination mobile unit (via the transceiver 514).

The RLP transceiver 514 may be any type of device that transmits and/or receives voice messages in a wireless fashion. For example, the transceiver 514 may include an antenna. In one example, the transmitter 514 may be omitted and transmissions may occur from the transceiver 502.

In one example of the operation of the infrastructure of FIG. 5, voice messages may be received at the transceiver 502. The voice messages may be received by the RLP code unit 506 (within the RLP terminator unit 504). After the RLP code unit 506 places the messages into the re-sequencing queue 508 (within the RLP terminator unit 504), the re-sequencing queue 508 may place the frames in the correct sequence, if the frames were received out-of-sequence. The re-sequencing queue 508 may send the frames to the controller 510.

The controller 510 can route the messages from the RLP terminator unit 504 to the output buffer 512. When ready for transmission, the controller 510 initiates transmission and the messages are sent from the output buffer 512 to the transmitter 514. The frames may then be transmitted to the destination mobile unit.

In another example of the operation of the infrastructure of FIG. 5, an RTP header may be received at the transceiver 514. The RTP header may be routed through the infrastructure, for example, by the controller 510, and can be transmitted to the source mobile unit via the transceiver 502.

Alternatively, a NAK may be generated by the infrastructure, for instance, by the controller 510, upon determination that an expected frame has not been received. In this case, it is assumed that a transmission error has occurred and the vocoding rate should be adjusted. Thus, in this example, an indication need not be formed in the destination mobile unit as described above, but may be generated (in the form of the NAK) in the infrastructure and sent to the source mobile unit.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

1. A method for regulating a remaining play-out depth of a play-out buffer in a destination mobile unit, the method comprising:
receiving at least one communication from a source mobile unit in a play-out buffer, the play-out buffer having an associated play-out depth;
playing the communications received at the play-out buffer to a recipient at the destination mobile unit;
determining the remaining play-out depth of the play-out buffer in the destination mobile unit; and
sending an indication to the source mobile unit when the remaining play-out depth of the play-out buffer in the destination mobile unit reaches a predetermined threshold.

2. The method of claim 1 comprising:
encoding and transmitting the communications from the source mobile unit to the destination mobile unit at a coding rate;
receiving the indication from the destination mobile unit; and
adjusting the coding rate of the communications sent from the source mobile unit to the destination mobile unit as a function, at least in part, of the indication received from the destination mobile unit.

3. The method of claim 2 wherein adjusting the coding rate of the source mobile unit comprises adjusting the coding rate of a vocoder in the source mobile unit.

4. The method of claim 1 wherein sending an indication comprises sending a real-time transport protocol (RTP) header.

5. The method of claim 2 wherein receiving an indication comprises receiving a negative acknowledgment message for a frame.

6. A method of regulating a coding rate of communications transmitted from a source wireless unit to a destination wireless unit, the method comprising:
encoding communications in a vocoder at the source mobile unit at a coding rate and transmitting the communications to the destination unit;
receiving an indication from the destination mobile unit; and
adjusting the coding rate of the vocoder in the source mobile unit according to the indication received from the destination mobile unit.

7. The method of claim 6 wherein receiving an indication comprises receiving a real-time transport protocol (RTP) header.

8. The method of claim 6 wherein receiving an indication comprises receiving a negative acknowledgment message.

9. The method of claim 8 wherein receiving the indication comprises receiving the NAK that originated because of a request for retransmission for a frame that was originally sent more than a threshold number of seconds in the past.

10. A system comprising:
a source mobile unit transmitting voice communications;
a wireless infrastructure coupled to the source mobile unit, the infrastructure receiving the voice communications from the source mobile unit and presenting the voice communications at an output; and
a destination mobile unit coupled to the wireless infrastructure at an output of the wireless infrastructure, the destination mobile unit receiving the voice communications from the infrastructure, the destination mobile unit comprising a play-out buffer, the play-out buffer having an associated play-out depth, the destination wireless unit storing the voice communications in the play-out buffer and forming an indication when the play-out depth reaches a predetermined threshold.

11. The system of claim 10 wherein the indication formed in the destination mobile unit is a real-time transport protocol (RTP) header.

12. The system of claim 10 wherein the wireless infrastructure forms a negative acknowledgment message that is passed to the source mobile unit.

13. The system of claim 10 comprising a supplemental communication channel from the destination mobile unit to the wireless infrastructure and wherein the indication is sent over the supplemental communication channel to the infrastructure and from the infrastructure to the source mobile unit.

14. A device for controlling a rate of incoming communications comprising:
a wireless transceiver having at least one output;
a play-out buffer having a play-out depth and storing communications received from a source mobile unit;
an indication register containing data representing remaining play-out depth of the play-out buffer;
a controller coupled to the play-out buffer and the indication register, the controller also coupled to the transceiver via an indication message output, the indication message output corresponding to contents of the indication register;
such that the wireless transceiver will transmit a communication that comprises the indication message output.

15. The device of claim 14 comprising means for playing the communications received at the play-out buffer to a recipient;

16. The device of claim 14 comprising means for determining the remaining depth of the play-out buffer.

17. The device of claim 14 wherein the indication of play-out depth is comprised in an RTP header.

18. A wireless transmission device comprising:
a transceiver having an indication message input;
a storage register coupled to the transceiver, the storage register storing at least one indication message received by the transceiver at the indication message input;
a vocoder having a communication output and a control input and further having an associated adjustable vocoder coding rate that is responsive to the control input; and
a controller that is operably coupled to the storage register and coupled to the vocoder by the control input, the controller forming a signal on the control input based upon contents of the at least one indication message present in the storage register.

19. The device of claim 18 wherein the indication message is a real-time transport protocol (RTP) header.

20. The device of claim 18 wherein the indication message received is a negative acknowledgment message.

21. The device of claim 18 wherein the controller comprises means for determining the content of the at least one indication message.
